(19) United States
(12) Patent Application Publication
(10) Pub. No.: US 2021/0110671 A1
(43) Pub. Date: Apr. 15, 2021

(54) METHOD AND SYSTEM FOR CONDUCTING A WAGERING GAME

(71) Applicants: Kenneth Baker, Las vegas, NV (US); Robert Honeycut, Las Vegas, NV (US)

(72) Inventors: Kenneth Baker, Las vegas, NV (US); Robert Honeycut, Las Vegas, NV (US)

(21) Appl. No.: 16/879,474

(22) Filed: May 20, 2020

Related U.S. Application Data
(60) Provisional application No. 62/851,012, filed on May 21, 2019.

(51) Int. Cl. G07F 17/32

(52) U.S. Cl. CPC G07F 17/3293; G07F 17/3211; G07F 17/3244

(57) ABSTRACT

A wagering game method includes dealing an initial poker hand, forming a final poker hand (optionally by discarding and replacing zero or more playing cards from the initial poker hand), and forming an augmented final poker hand by dealing additional cards to the final poker hand. Optionally, multiple augmented final poker hands may be formed from a single final poker hand by dealing additional cards from different decks to the same final poker hand. The augmented final poker hands are evaluated and a reward is issued based on the payout, if any, associated with the poker rank of each augmented final poker hand.

### FIELD OF THE INVENTION

The present invention relates to methods and systems for conducting wagering games. More particularly, the present invention is a method and system for conducting a wagering game in which a initial poker hand is dealt, a final poker hand is formed, then the final poker hand is augmented and a reward is issued based on the augmented final poker hand.

### BACKGROUND OF THE INVENTION

A game well known in the gambling industry is video poker. In the conventional game of video poker known in the art, a gaming machine with an incorporated data processor and display is provided. The gaming machine receives a player's wager thereby prompting the data processor to randomly select a hand of cards from a data storage containing data representing a deck of playing cards. The hand of cards, typically five cards, is displayed face up to represent an initial hand.

The player selects which, if any, of the five cards of the initial hand to hold and prompts the data processor, through an input device, to discard the remaining cards. The data processor replaces the discarded cards with cards selected from the data storage containing data representing a deck of cards depleted of the initial hand. The replacements along with the held cards form a final hand.

The data processor compares the final outcome to a set of pre-determined winning combinations stored in the data storage. Typically, these combinations represent the conventional ranked poker hands such as a pair of Jacks or better, two pair, three of a kind, and so forth. If the player's final outcome matches a winning combination, the player is rewarded according to a predetermined fixed pay table. Otherwise, the final outcome is deemed to be a loss and the player's wager is retained by the gaming machine.

There are many variations on conventional video poker. For example, wild cards may be designated such as in the well-known games of Deuces Wild, Jokers Wild, and the like. Other variations are directed to poker games in which a player may conduct multiple game hands. In one such example, shown in U.S. Pat. No. 5,823,873 to Moody, a player makes a separate wager for each game hand the player wishes to conduct. A first game hand is dealt face-up and the remaining game hands are displayed face-down. The player selects cards from the main game hand to be held and the cards held from the first game hand are copied into the other game hands. Independently generated replacement cards are dealt to each of the game hands. Each game hand is evaluated separately against a pay table and the decision to issue an award or retain the player's wager is made separately for each game hand.

### SUMMARY OF THE INVENTION

The present invention includes a method and device for conducting a wagering game. A method according to an embodiment of the present invention may be conducted at a device. Optionally, a device has a data processor in communication with a data storage device, a display, and a player interface. The data storage device stores, in non-transitory storage, playing cards and program instructions executable by the data processor to conduct a method.

In one optional embodiment, a wager is received through the player interface. An initial poker hand of playing cards is dealt by the data processor and displayed at the display. A final poker hand is formed by the data processor. Optionally, the final poker hand is formed by receiving an election through the player interface of held playing cards in the initial poker hand. Any playing cards not elected to be held are discarded from the initial poker hand and replaced with a replacement playing card. In an alternate optional embodiment, an election is received through the player interface of playing cards to be discarded from the initial poker hand, rather than those to be held. Again, any playing cards elected to be discarded is removed from the initial poker hand and replaced with a replacement playing card. Optionally, the final poker hand is displayed at the display.

In an optional embodiment, a reward is issued by the data processor based on the final poker hand. For example, in one such optional embodiment, a pay table of poker hand ranks and associated payouts is stored at the data storage device. A reward is determined based on the payout, if any, associated with the poker hand rank of the final poker hand. Alternatively, no reward is issued based on the final poker hand with rewards only available for the augmented final poker hands as described in greater detail below.

At least one augmented final poker hand is formed by the data processor by dealing at least one additional card to the final poker hand. In a further optional embodiment, a plurality of augmented final poker hands are formed by the data processor. Each augmented final poker hand consists of the final poker hand plus at least one additional playing card such that multiple augmented final poker hands are formed from a single final poker hand. In one optional embodiment, the same quantity of playing cards are added to the final poker hand to form each augmented final poker hand. In an alternate optional embodiment, a different quantity of playing cards are added to the final poker hand to form each augmented final poker hand. Regardless of the quantity of additional playing cards dealt to form each augmented final poker hand, it is contemplated that the playing cards stored at the data storage device may constitute one or more poker decks such that the cards dealt to form each augmented final poker hand are dealt from a separate poker deck depleted of at least the final poker hand. In a further optional embodiment in which the final poker hand is formed by discarding and replacing zero or more playing cards from the initial poker hand, each poker deck from which the additional playing cards are dealt may be depleted by the final poker hand and any discarded cards.

A reward is issued by the data processor based on the augmented final poker hands. For example, in one such optional embodiment, poker hand ranks are stored at the data storage device, with the rank of each augmented final poker hands based on the highest possible poker hand rank formed from each augmented final poker hands. In a further optional embodiment, a pay table of poker hand ranks and associated payouts is stored at the data storage device. A reward is determined by the data processor based on the payouts, if any, associated with the poker hand rank of each augmented final poker hand.

The present invention also includes a device for conducting a wagering game. In an optional embodiment, a device includes a data processor. The data processor is in communication with a display, a player interface, and a data storage device. In one such optional embodiment, the data storage device stores, in non-transitory storage, playing cards and program instructions executable by the data processor. Among the program instructions may be program instructions for conducting a wagering game.

In an optional embodiment, a wager is received through the player interface and an initial poker hand of playing cards is dealt by the data processor. Optionally, the initial poker hand is displayed at the display.

A final poker hand is formed by the data processor and displayed at the display. While the final poker hand may be formed in any manner, in one optional embodiment, the final poker hand is formed by receiving an election through the player interface of playing cards in the initial poker hand to be held (or, alternatively, playing cards in the initial poker hand to be discarded), discarding from the initial poker hand any playing cards not elected to be held, and replacing each discarded playing card with a replacement playing card.

In an optional embodiment, a reward is issued by the data processor based on the final poker hand. For example, in one such optional embodiment, a pay table of poker hand ranks and associated payouts is stored at the data storage device and a reward is issued by the data processor based on the payout, if any, associated with the poker hand rank of the final poker hand.

At least one augmented final poker hand is formed from the final poker hand plus at least one additional playing card. In a further optional embodiment, a plurality of augmented final poker hands are formed by the data processor. Each augmented final poker hand includes the final poker hand plus at least one additional playing card such that a plurality of augmented final poker hands are formed from a single final poker hand. In one optional embodiment, the same quantity of playing cards are added to the final poker hand to form each augmented final poker hand. In an alternate optional embodiment, a different quantity of playing cards are added to the final poker hand to form each augmented final poker hand. Without regard to the quantity of playing cards added to the final poker hand to form each augmented final poker hand, in one optional embodiment, the playing cards stored at the data storage device constitute a poker deck and the additional playing card(s) dealt to form each augmented final poker hand is dealt from a separate poker deck depleted of at least the final poker hand. In an optional embodiment in which the final poker hand is formed by discarding and replacing playing cards from an initial poker hand, the additional cards dealt to form the augmented final poker hands may be dealt from separate decks depleted of the final poker hand and any discarded playing cards.

A reward is issued by the data processor based on the augmented final poker hands. In an optional embodiment, poker hand ranks are stored at the data storage device such that the rank of each augmented final poker hands is based on the highest possible poker hand rank formed from each augmented final poker hands. In one such optional embodiment, a pay table of poker hand ranks and associated payouts is stored at the data storage device and a reward is issued by the data processor based on the payout, if any, associated with the poker hand rank of each augmented final poker hand.

### BRIEF DESCRIPTION OF THE DRAWINGS

FIG. 1A is a front view of a display of a game according to an embodiment of the present invention;

FIG. 1B is a front view of a display of the game of FIG. 1A;

FIG. 1C is a front view of a display of the game of FIG. 1A;

FIG. 1D is a front view of a display of the game of FIG. 1A;

FIG. 1E is a front view of a display of the game of FIG. 1A;

FIG. 2A is a front view of a display of a game according to an embodiment of the present invention;

FIG. 2B is a front view of a display of the game of FIG. 2A;

FIG. 2C is a front view of a display of the game of FIG. 2A;

FIG. 2D is a front view of a display of the game of FIG. 2A;

FIG. 2E is a front view of a display of the game of FIG. 2A;

FIG. 3 is a flow chart of a method according to an embodiment of the present invention;

FIG. 4 is a block diagram of a device according to an embodiment of the present invention.

### DESCRIPTION

Reference is now made to the figures wherein like parts are referred to by like numerals throughout. The present invention includes a method and device for conducting a wagering game. Although the optional embodiment illustrated in the examples and figures is directed to a five-card draw poker game, it is contemplated that the quantity of playing cards and nature of the game may vary depending on the embodiment. For example, the present invention may be directed to three-card games, four-card games, five-card games, or a game using any other quantity of playing cards. Similarly, the present invention may be directed to draw poker, stud poker, hold'em poker, or any other type of game.

Likewise, the examples and figures illustrate an optional embodiment in which a conventional poker deck of playing cards is used, e.g., playing cards with values deuce through Ace in four suits for a total of fifty-two playing cards. It is contemplated that in alternate optional embodiments, certain values, such as deuces may be treated as wild cards that may substitute for any other value in a hand. Additionally or alternatively, the deck constitution could include additional cards (such as Jokers or other wild cards), or omit cards (such as in a Spanish deck).

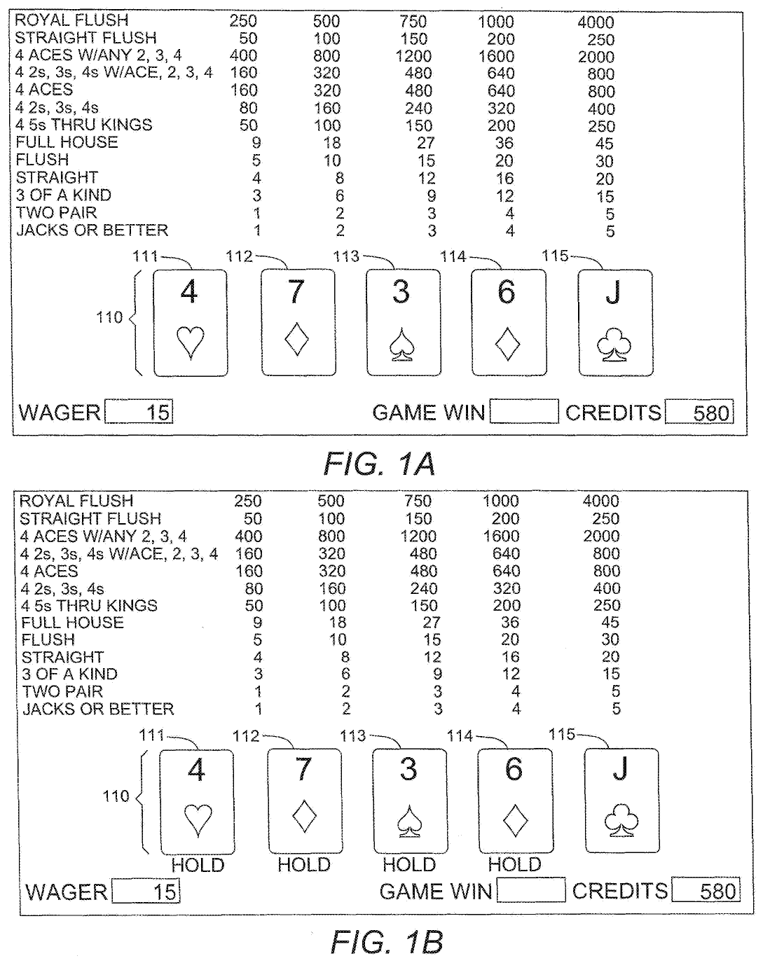

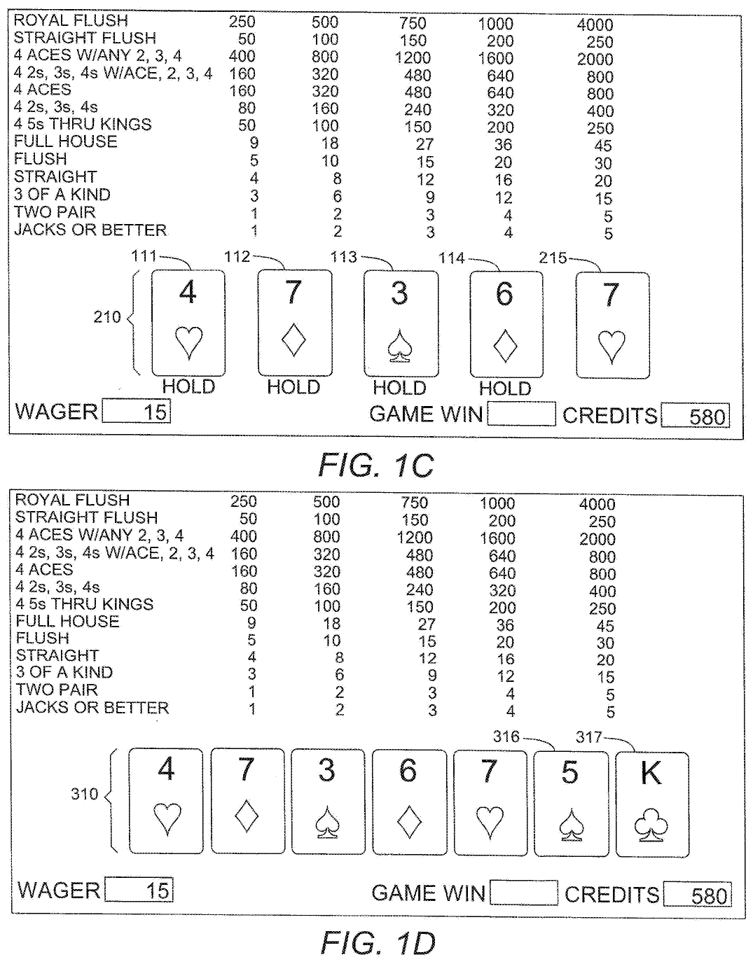

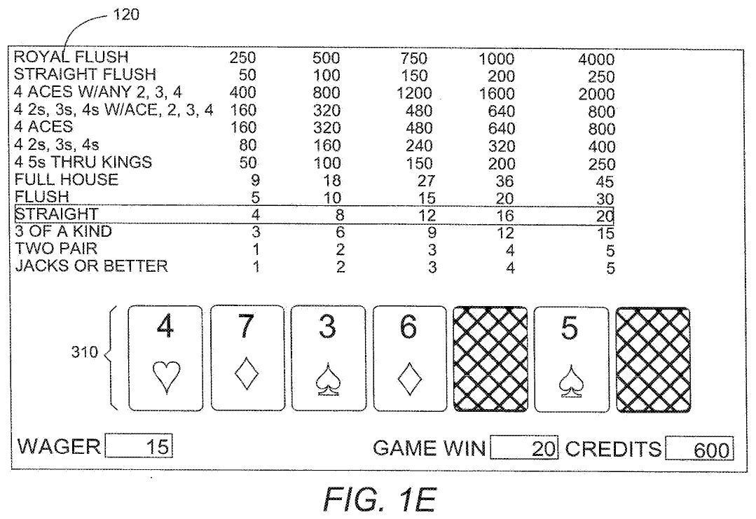

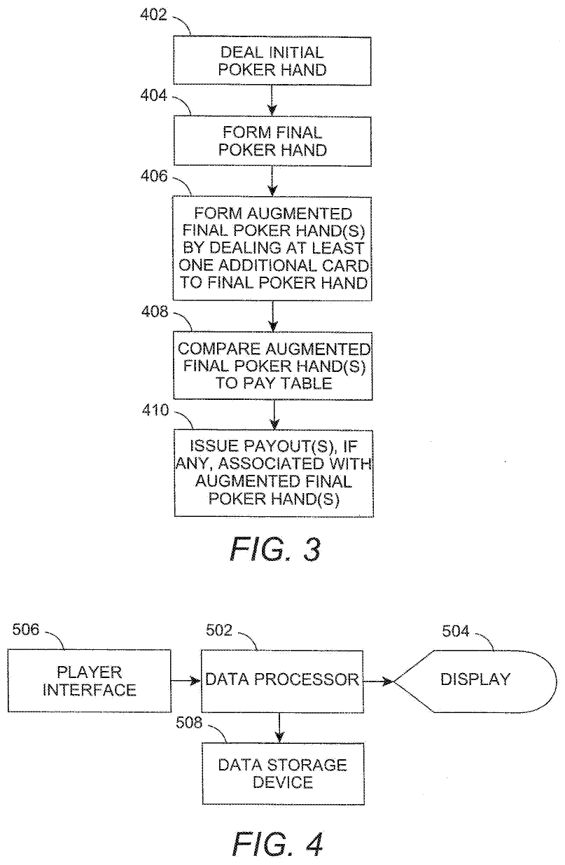

Referring generally to FIGS. 1-3, a wager is received and an initial poker hand is dealt 402. The wager may be of any size or denomination. In an optional embodiment in which multiple augmented final poker hands are formed, the wager may account for the fact that the player will eventually form multiple augmented final poker hands and, thus, the wager may be increased accordingly.

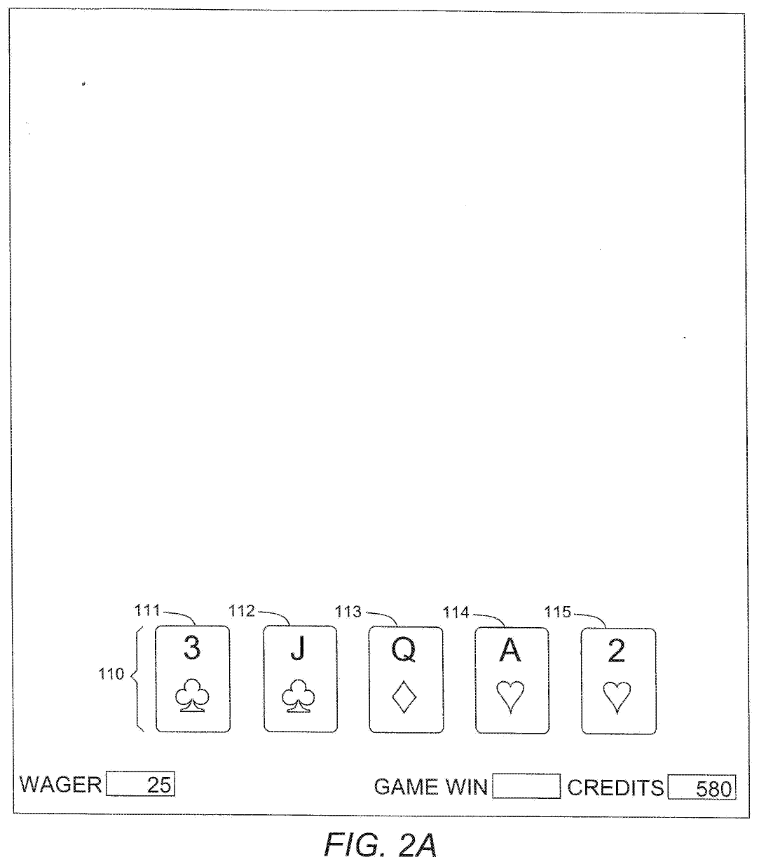

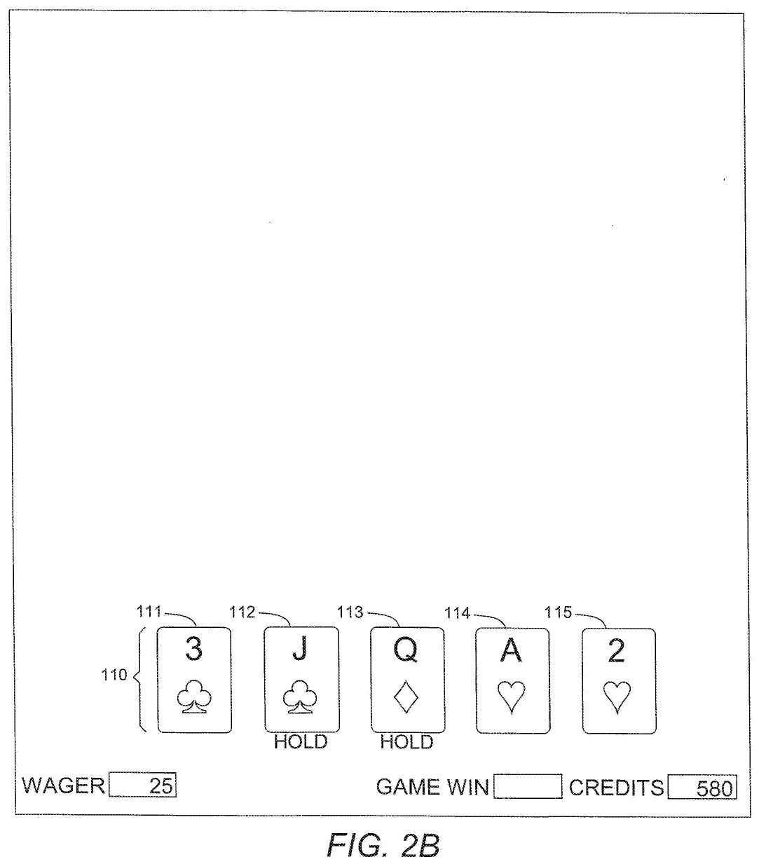

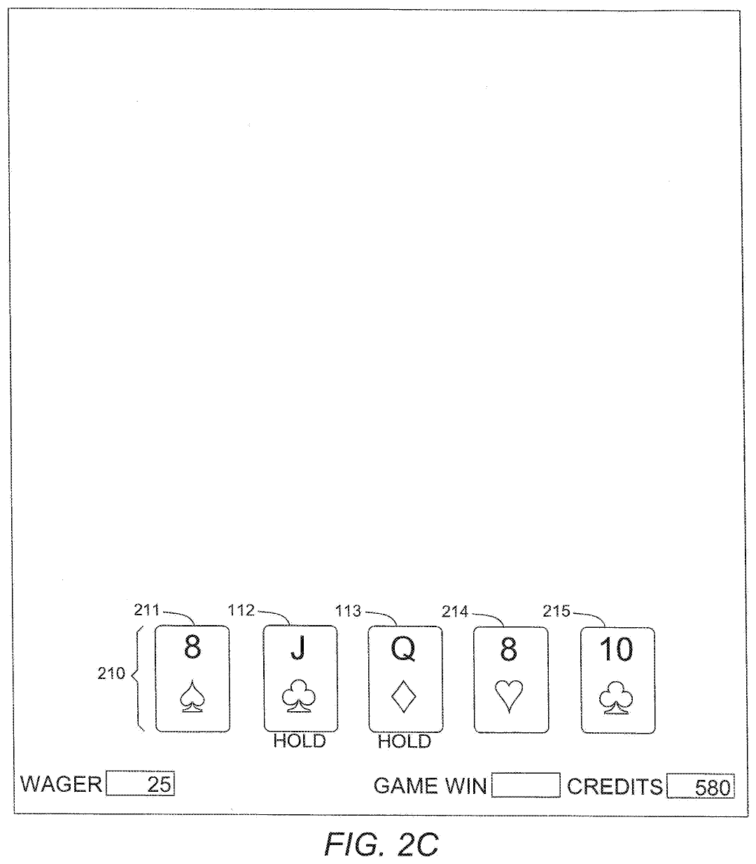

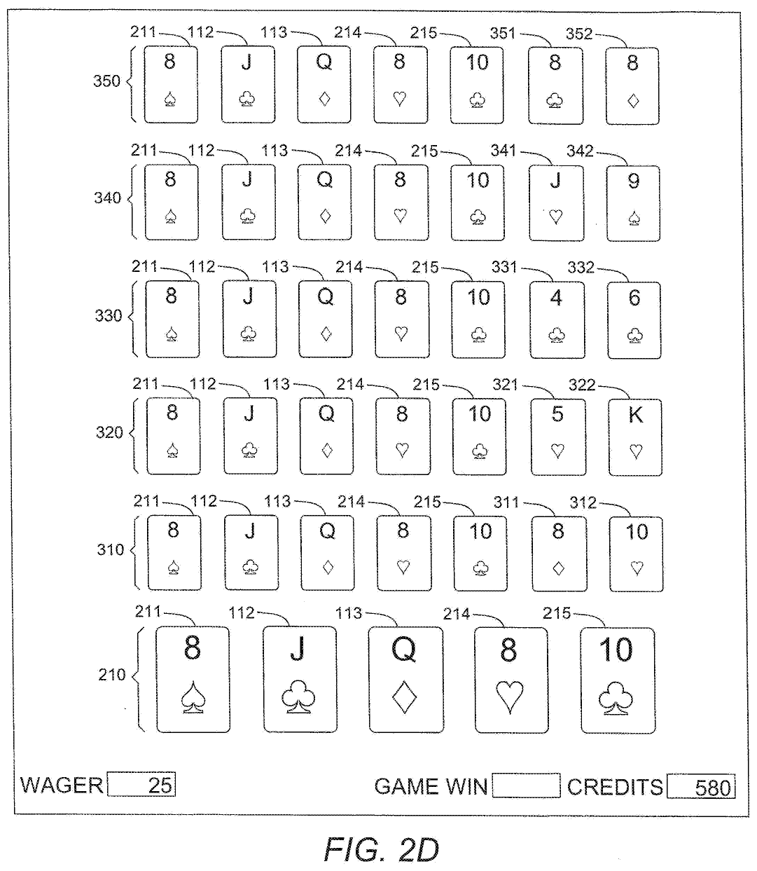

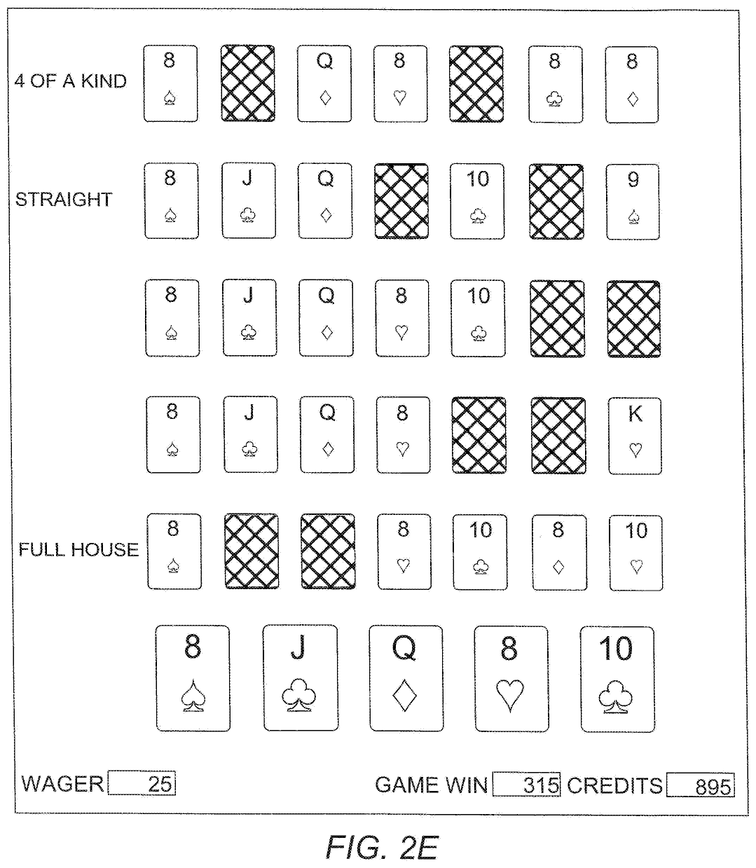

The initial poker hand may include any quantity of playing cards. In the example illustrated in FIGS. 1A-1E and 2A-2E, an initial poker hand 110 includes five playing cards. However, it is contemplated that the initial poker hand may include any quantity of playing cards.

A final poker hand is formed 404 from the initial poker hand. The process of forming the final poker hand may vary depending on the optional embodiment. For example, in an optional embodiment directed to stud poker, the initial poker hand and final poker hand may be the same hand, e.g., no action may be required or allowed to form a final poker hand from the initial poker hand.

In another optional embodiment directed to hold'em poker or similar games, the final poker hand may be formed using one or more hole or pocket cards in combination with one or more community cards. Thus, in such an optional embodiment, a final poker hand may be formed, at least in part, by dealing one or more community cards to be combined with the initial poker hand to form a final poker hand.

In yet another optional embodiment directed to draw poker, a final poker hand may be formed from an initial poker hand by designating zero or more cards in the initial poker hand to be held (or discarded), discarding the cards that are not held, and replacing the discarded cards, For example, in one such example, a player may be dealt a five-card initial poker hand and designate four cards to be held (or one card to be discarded) so that the player receives one replacement card for each discarded card and, at the end of the hand, holds a five-card final poker hand.

In the examples of FIGS. 1A-1E and 2A-2E, the final poker hand is formed from an initial poker hand by selecting playing cards to be held and discarding the cards not designated. It is contemplated that in an alternate optional embodiment, the final poker hand may likewise he formed from the initial poker hand by selecting playing cards to be discarded and retaining the cards not designated. In either case, zero or more cards are removed from the initial poker hand and replaced with newly dealt cards. In an optional embodiment, a single deck of cards is used and the discarded cards are removed from play, that is, are ineligible to be dealt as replacement cards. In such an optional embodiment, for example, if a player discards 80 from his or her hand, the player cannot receive the 80 among the replacement cards.

In an optional embodiment, the final poker hand may be evaluated and a reward issued based on the final poker hand. For example, in one such optional embodiment, a pay table of poker hand ranks and associated payouts may be defined. The final poker hand may be compared to the pay table and any payout associated with the final poker hand may be issued to the player. It is contemplated that in such an optional embodiment, any pay table may be used. For example, a pay table with payouts for conventional poker hands such as straight, flush, four of a kind, and so forth may be defined.

In another optional embodiment, the final poker hand is not evaluated or rewarded. That is, the final poker hand may merely be an intermediate step in the game as discussed in greater detail below.

In either case, at least one augmented final poker hand is formed, In one optional embodiment, illustrated in FIGS. 1A-1E, exactly one augmented final poker hand is fixated. In another optional embodiment, illustrated in FIGS. 2A-2E, multiple augmented final poker hands may be formed from the same final poker hand.

An augmented final poker hand is formed 406 by dealing at least one additional playing card to the final poker hand. In the examples of FIGS. 1A-1E and 2A-2E, a final poker hand includes five cards and an augmented final poker hand includes seven cards, with two additional playing cards dealt to the five-card final poker hand to form a seven-card augmented final poker hand. It is contemplated that the final poker hand may include any quantity of playing cards. Thus, in an alternate optional embodiment, one, three, or any other quantity of additional playing cards may be dealt to a final poker hand to form an augmented final poker hand.

In an optional embodiment in which multiple augmented final poker hands are formed, each augmented final poker hand may include the same quantity of playing cards or may each include different quantities of playing cards. That is, the same quantity of additional playing cards may be dealt to the final poker hand to form each augmented final poker hand, or different quantities of playing cards may be dealt to the final poker hand to form each augmented final poker hand. Thus, in one such optional embodiment, each augmented final poker hand may include the final poker hand plus two additional playing cards (as illustrated in FIGS. 2A-2E) or each augmented final poker hand may include the final poker hand plus varying quantities of additional playing cards (not shown).

Similarly, in an optional embodiment directed to multiple augmented final poker hands, the additional cards dealt to the final poker hand to form each augmented final poker hand may be dealt from a single deck of playing cards or from different decks of playing cards. That is, in forming a first augmented final poker hand, additional cards may be dealt from a first deck, whereas a second augmented final poker hand may be formed using additional playing card dealt from a separate, second deck. It is contemplated that each deck may be depleted of the final poker hand and, optionally, any card dealt to the initial poker hand and discarded. For example, if a player has a final poker hand of 8♥, 9 [symbol] , J [symbol] , K [symbol] , K♦ and discarded 3♥, 7 [symbol] , 9♦ from the initial poker hand before forming the final poker hand, the cards 8♥, 9 [symbol] , J [symbol] , K [symbol] , K♦, 3♥, 7 [symbol] , 9♦ may be depleted from any deck or decks used to deal additional cards in forming the augmented final poker hands.

It is noted here that in an optional embodiment with multiple augmented final poker hands, each augmented final poker hand incorporates the final poker hand. That is, each includes the final poker hand as a base, and builds on that base with additional playing cards dealt to the final poker hand. In this respect, each augmented final poker hand is a variation on the same final poker hand, with the additional cards being available to improve or alter the holding in the final poker hand.

Each augmented final poker hand is evaluated and rewards are issued. For example, in one optional embodiment, each augmented final poker band is compared 408 to a pay table of winning hands and corresponding payouts. Again, the winning hands may be conventional poker hand rankings such as Jacks or better, two pair, three of a kind, and so forth. In one optional embodiment, the augmented final poker hand includes more cards than are necessary to form a winning holding. For example, the augmented final poker hand may include seven cards, with each winning holding containing five cards. In such an optional embodiment, the augmented final poker hand may be evaluated based on the highest ranking poker hand that may be formed from the cards in the augmented final poker hand.

A reward is issued based on the evaluation. In one optional embodiment utilizing a pay table, the reward may be the payout or payouts, if any, associated with the augmented final poker hand or augmented final poker hands, as the case may be. In an optional embodiment directed to multiple augmented final poker hands, the payouts may be aggregated so that the player may earn multiple payouts from multiple augmented final poker hands.

Referring to the example in FIGS. 1A-1E, an initial poker hand 110 may include five playing cards 111, 112, 113, 114, 115. In this example, the initial poker hand includes the playing cards 4♥, 7♦, 3 [symbol] , 6♦, J [symbol] as illustrated in FIG. 1A. Based on the pay table 120 displayed to the player, the player may choose to hold the first four cards 111, 112, 113, 114 in an attempt to draw to an inside straight as illustrated in FIG. 1B. That is, the player may choose to hold the playing cards 4♥, 7♦, 3 [symbol] , 6♦ in the hope that the replacement for the J [symbol] is a five of any suit. As illustrated in FIG. 1C, a replacement card 215 is dealt to replace the discarded card. In this example, the replacement card is 7♦. Thus, the final poker hand 210 in this example is 4♥, 7♦, 3 [symbol] , 6♦, 7♥.

The augmented final poker hand 310 is formed. It is noted that in this optional embodiment, the augmented final poker hand is always formed, i.e., no trigger is required to form an augmented final poker hand. It is contemplated, however, that in alternate optional embodiments, the augmented final poker hand may be formed only upon election by the player, upon a game trigger, or the like. In any event, two additional playing cards 316, 317 are dealt to the final poker hand. In this case, the additional playing cards are 5 [symbol] , K [symbol] so that the augmented final poker hand includes 4♥, 7♦, 3 [symbol] , 6♦, 7♥, 5 [symbol] , K [symbol] as illustrated in FIG. 1D. The augmented final poker hand may be evaluated. As illustrated in FIG. 1E, the evaluation may be based on a pay table 120, and the evaluation may be illustrated to the player by removing or dimming playing cards not included in the final evaluation. In this example, a seven-high straight may be formed from the augmented final poker hand 310 so a seven (the 7♥, in this example, although the 7♦ could alternatively be selected) and the king (the K [symbol] ) are dimmed. The player may be rewarded based on the payout associated with a straight, in this case twenty credits, based on the player's wager, in this case fifteen credits.

Referring to the example of FIGS. 2A-2E, in an optional embodiment an initial poker hand 110 is dealt, in this case, the initial poker hand consists of five playing cards 111, 112, 113, 114, 115. In the example illustrated in FIG. 2A, the initial poker hand is 3 [symbol] , J [symbol] , 2♦, A♥, Q♥. As shown in FIG. 2B, the player may elect to hold the cards J [symbol] , Q♥ and discard and replace the remaining cards. As illustrated in FIG. 2C, three replacement cards 211, 214, 215 may be dealt to the final poker hand 210. In this example the replacement cards are 8 [symbol] , 8♥, 10 [symbol] so that the final poker hand is 8 [symbol] , J [symbol] , Q♥, 8♥, 10 [symbol] .

As shown in FIG. 2D, multiple augmented final poker hands 310, 320, 330, 340, 350 are formed using the final poker hand 210 as a base. Specifically, two additional cards 311, 312 of 8♦, 10♥ are dealt to the final poker hand 210 to form a first augmented final poker hand 310 of 8 [symbol] , J [symbol] , Q♥, 8♥, 10 [symbol] , 8♦, 10♥; two additional cards 321, 322 of 5♥, K♥ are dealt to the final poker hand 210 to form a second augmented final poker hand 320 of 8 [symbol] , J [symbol] , Q♥, 8♥, 10 [symbol] , 5♥, K♥; two additional cards 331, 332 of 4 [symbol] , 6 [symbol] are dealt to the final poker hand 210 to form a third augmented final poker hand 330 of 8 [symbol] , J [symbol] , Q♥, 8♥, 10 [symbol] , 4 [symbol] , 6 [symbol] ; two additional cards 341, 342 of J♥, 9 [symbol] are dealt to the final poker hand 210 to form a fourth augmented final poker hand 340 of 8 [symbol] , J [symbol] , Q♥, 8♥, 10 [symbol] , J♥, 9 [symbol] ; two additional cards 351, 352 of 8 [symbol] , 8♦ are dealt to the final poker hand 210 to form a fifth augmented final poker hand 350 of 8 [symbol] , J [symbol] , Q♥, 8♥, 10 [symbol] , 8 [symbol] , 8♦. As shown in FIG. 2E, cards not used in determining the ranking of an augmented final poker hand may be dimmed or removed and the poker ranking formed by the hand may be displayed. In this example, a first augmented final poker hand 310 may form a full house, a fourth augmented final poker hand 340 may form a straight, and a fifth augmented final poker hand 350 may form a four of a kind.

The present invention also includes a device for conducting a wagering game. The form of the device may vary depending on the optional embodiment, including an electronic gaming machine, personal computer, cellular telephone, handheld device, kiosk, electronic gaming table, or the like. In any event, the device may include a data processor 502 in communication with a display 504, a player interface 506, and a data storage device 508. The display 504 may take any form, including a liquid crystal display (“LCD”), organic light emitting diode (“OLED”) display, cathode ray tube (“CRT”) monitor, plasma display, or the like. The player interface 506 may include physical or mechanical buttons, such as those mounted on a button panel, or other input devices. Additionally or alternatively, the player interface 506 may be combined with the display 504 in a touchscreen device. The data storage device 508 may take any form, including optical storage, magnetic storage, flash memory, or any other type of non-transitory data storage.

In an optional embodiment, the data storage device 508 stores files and parameters used in the conduct of the game, such as sounds, graphics, maps for the random number generator, and the like, as well as program instructions executable by the data processor 502 to conduct the game. For example, in an optional embodiment, the program instructions include receiving a wager through the player interface 506. As may be understood, the wager may be received by receiving input through an input device, such as a touchscreen, or physically receiving the wager through a ticket reader, bill acceptor, coin receiver, or the like.

In response to the receipt of a wager, an initial poker hand is dealt by the data processor 502. In an optional embodiment, the data processor 502 communicates with, incorporates, or executes a random number generator which generates a random number that is mapped to a playing card or set of playing cards used in forming the initial poker hand. The initial poker hand is optionally displayed at the display 504.

A final poker hand is formed by the data processor. In an optional embodiment, the final poker hand is formed, at least in part, based on input received by the data processor 502 through the player interface 506. For example, in an optional embodiment directed to draw poker, input may be received to designate zero or more playing cards of the mitral poker hand to hold (or, alternatively, to discard). In response, the data process or such an optional embodiment deals replacement cards for the discarded cards and, optionally, displays the final poker hand at the display 504.

The data processor 502 forms at least one augmented final poker hand. As discussed above, the data processor 502 may form a single augmented final poker hand or may form multiple augmented final poker hands. In either case, each augmented final poker hand is formed by the data processor dealing at least one additional playing card to the final poker hand. As discussed above, where multiple augmented final poker hands are formed, each may include the same or different quantities of additional playing cards and each set of additional playing cards may be dealt from separate decks of playing cards.

The augmented final poker hands are evaluated, optionally by comparing each augmented final poker hand to a pay table stored in the data storage device. Optionally the data storage device stores poker hand ranks in addition to the pay table, so that the poker hand rank of the augmented final poker hand can be determined then compared to the pay table of winning hands and associated pay outs to determine the pay out, if any, for the augmented final poker hand. Where multiple augmented final poker hands are formed, the pay outs may be aggregated into a single reward.

While certain embodiments of the present invention have been shown and described it is to be understood that the present invention is subject to many modifications and changes without departing from the spirit and scope of the invention presented herein.

1. A method for conducting a wagering game at a device having a data processor in communication with a data storage device, a display, and a player interface, said data storage device storing, in non-transitory storage, playing cards and program instructions executable by said data processor to conduct a method comprising the steps of:
receiving a wager through said player interface;
dealing an initial poker hand of playing cards by said data processor and displaying said initial poker hand at said display;
forming a final poker hand by said data processor and displaying said final poker hand at said display;
forming at least one augmented final poker hand by said data processor, wherein each said augmented final poker hand comprises said final poker hand plus at least one additional playing card; and
issuing a reward by said data processor based on said a augmented final poker hands.

2. The method of claim 1 wherein a plurality of augmented final poker hands are formed by said data processor, wherein each said augmented final poker hand comprises said final poker band plus at least one additional playing card such that said plurality of augmented final poker hands are formed from a single final poker hand.

3. The method of claim 2 further comprising storing a pay table of poker hand ranks and associated payouts, wherein said step of issuing a reward by said data processor base on said augmented final poker hands comprises issuing a payout, if any, associated with the poker hand rank of each augmented final poker hand.

4. The method of claim 1 further comprising issuing a reward by said data processor based on said final poker hand.

5. The method of claim 4 further comprising storing a pay table of poker hand ranks and associated payouts, wherein said step of issuing a reward by said data processor based on said final poker hand comprises issuing a payout, if a associated with the poker hand rank of said final poker hand.

6. The method of claim 1 wherein the same quantity of playing cards are added to the final poker hand to form each augmented final poker hand.

7. The method of claim 1 wherein a different quantity of playing cards are added to the final poker hand to form each augmented final poker hand.

8. The method of claim 1 wherein said playing cards stored at said data storage device constitute a poker deck and wherein each said augmented final poker hand comprises staid final poker hand plus least one additional playing card dealt from a separate poker deck depleted of at least said final poker hand.

9. The method of claim 1 wherein said step of forming a final poker hand comprises receiving an election through said player interface of held playing cards in said initial poker hand, discarding from said initial poker hand any playing cards not elected to be held, and replacing each said discarded playing card with a replacement playing card.

10. The method of claim 1 wherein said step of forming a final poker hand comprises receiving an election through said player interface of playing cards to be discarded from said initial poker hand, discarding from said initial poker hand any playing cards elected to be discarded, and replacing each said discarded playing card with a replacement playing card.

11. A device for cc conducting wagering game comprising:
a data processor;
a display in communication with said data processor;
a player interface in communication with said data processor; and
a data storage device in communication with said data processor, said data storage device storing, in non-transitory storage, playing cards and program instructions executable by said data processor conduct a wagering game comprising the steps of:
receiving a wager through said player interface;
dealing an initial poker hand of playing cards by said data processor and displaying said initial poker hand at said display;
forming a final poker hand by said data processor and displaying said final poker hand at said display;
forming at least one augmented final poker hand by said data processor, wherein each said augmented final poker hand comprises said final poker hand plus at least one additional playing card; and
issuing a reward by said data processor based on said augmented final poker hands.

12. The device of claim 11 wherein said program instructions further comprise forming a plurality of augmented final poker hands, wherein each said augmented final poker hand comprises said final poker hand plus at least one additional playing card such that said plurality of augmented final poker hands are formed from a single final poker hand.

13. The device claim 11 wherein said program instructions further comprise storing a pay table of poker hand ranks and associated payouts, wherein said step of issuing a reward by said data processor based on said augmented final poker hands comprises issuing a payout, if any, associated with the poker hand rank of each augmented final poker hand.

14. The device of claim 11 wherein said program instructions further comprise issuing a reward by said data processor based on said final poker hand.

15. The device of claim 14 wherein said program instructions further comprise storing a pay table of poker hand ranks and associated payouts, wherein said step of issuing a reward by said data processor based on said final poker hand comprises issuing a payout, if any, associated with the poker hand rank of the final poker hand.

16. The device of claim 11 wherein said program instructions comprise adding the same quantity of playing cards to the final poker hand to form each augmented final poker hand.

17. The device of claim 11 wherein said program instructions comprise adding a different quantity of playing cards to the final poker hand to form each augmented final poker hand.

18. The device of claim 11 wherein said playing cards stored at said data storage device constitute a poker deck and wherein each said augmented final poker hand comprises said final poker hand plus at least one additional playing card dealt from a separate poker deck depleted of at least said final poker hand.

19. The device of claim 11 wherein said step in said program instructions of forming a final poker hand comprises receiving an election through said player interface of held playing cards in said initial poker hand, discarding from said initial poker hand any playing cards not elected to be held, and replacing each said discarded playing card with a replacement playing card.

20. The device of claim 11 wherein said step in said program instructions of forming a final poker hand comprises receiving an election through said player interface of playing cards to be discarded from said initial poker hand, discarding from said initial poker hand any playing cards elected to be discarded, and replacing each said discarded playing card with a replacement playing card.
